(19) United States
(12) Patent Application Publication
(10) Pub. No.: US 2008/0143779 A1
(43) Pub. Date: Jun. 19, 2008

(54) FLUID INJECTION APPARATUS

(75) Inventor: Atsushi YOSHIDA, Shiojiri-shi (JP)

Correspondence Address: SUGHRUE MION, PLLC, 2100 Pennsylvania Avenue, N.W., Washington, DC, 20037, US

(73) Assignee: Seiko Epson Corporation, Tokyo (JP)

(21) Appl. No.: 11/959,894

(22) Filed: Dec. 19, 2007

(30) Foreign Application Priority Data
Dec. 19, 2006 (JP) 2006-341525
Nov. 8, 2007 (JP) 2007-290845

(51) Int. Cl. B41J 2/165

(52) U.S. Cl. 347/30

(57) ABSTRACT

A fluid injection apparatus comprises a fluid injection head, a capping member, a tank, a fluid flow path, a drive motor, a suction pump, and a shift preventing apparatus. The fluid injection head has a nozzle forming surface. A nozzle for injecting a fluid onto a target is provided on the nozzle forming surface. The capping member makes contact with the fluid injection head in a state where the fluid can be sucked from the nozzle and includes a cap portion which is formed to receive the fluid. The tank collects and holds the fluid discharged from the fluid injection head via the capping member. The fluid flow path connects the cap portion to the tank. The drive motor is rotatable in both forward and reverse directions. The suction pump sucks the fluid through the inside of the cap portion and the fluid flow path and feeding the fluid toward the tank when the drive motor rotates in the forward direction in the state where the fluid injection head and the capping member make contact with each other. The shift preventing apparatus prevents a positive pressure within the suction pump from shifting into the cap portion by the rotation of the drive motor in the reverse direction when the rotation of said drive motor is switched from the forward direction to the reverse direction.

### CROSS-REFERENCE TO RELATED APPLICATION

This application is based upon and claims the benefit of priority from prior Japanese Patent Application No. 2006-341525 filed on Dec. 19, 2006 and Japanese Patent Application No. 2007-290845 filed on Nov. 8, 2007, the entire contents of which are incorporated herein by reference.

### FIELD OF THE INVENTION

The present invention relates to a fluid injection apparatus such as an ink jet printer.

### BACKGROUND

In general, ink jet printers are widely known as a fluid injection apparatus for injecting a fluid onto a target through a fluid injection head. In these printers, a problem arises where the ink solvent evaporates through the nozzle of a recording head, which is a fluid injection head, and thus, the viscosity of the ink increases, the ink solidifies, dust adheres, and bubbles are mixed in the nozzle, causing the nozzle to be clogged and defects in printing. In order to solve this problem, typical printers include a maintenance apparatus for cleaning the inside of the nozzle of the recording head by forcefully sucking and discharging the ink, bubbles and the like (e.g., see Japanese Laid-Open Patent Publication NO. 10-181034).

The maintenance apparatus described in Japanese Laid-Open Patent Publication NO. 10-181034 includes a capping member which makes contact with and surrounds a number of nozzles provided on the nozzle forming surface of a recording head, a waste fluid tank which is connected to the capping member via a discharge tube, and a suction pump in tube form which is disposed in the discharge tube. A plurality of small ink chambers (cap portions) are partitioned in the capping member in order to divide the nozzle forming surface of the recording head into a plurality of regions to be sucked. The discharge tube is divided into a plurality of fluid flow paths on the upstream side of the suction pump (i.e., on the side of the capping member) and each fluid flow path is individually connected to the inside of each small ink chamber. Furthermore, the suction pump exerts a suction force when the drive motor, which is rotatable in both forward and reverse directions, rotates in the forward direction.

The maintenance apparatus includes a switching valve apparatus. The switching valve apparatus selectively opens and closes the valve bodies each of which selectively switches each fluid flow path between in a connected state and in a disconnected state. In addition, when the suction pump is driven by the forward rotation of the drive motor, the ink is discharged only into the small ink chambers which correspond to the fluid flow paths in the connected state via the nozzles of the recording head. In other words, the recording head is selectively cleaned by driving the switching valve apparatus.

In some recent maintenance apparatuses, the drive force caused by the rotation is transmitted to the switching valve apparatus only when the drive motor rotates in the reverse direction. In other words, such a switching valve apparatus selectively opens and closes each of the valve bodies as described above through the drive force transmitted from the drive motor rotating in the reverse direction.

In the case where the rotation of the drive motor is switched from the forward direction to the reverse direction in the state that the capping member makes contact with the recording head, however, the positive pressure within the suction pump shifts to the upstream side (cap side) through each fluid flow path in order to reduce the difference in the pressure inside the suction pump. When one or more valve bodies in the closed state are opened as a result of the reverse rotation of the drive motor in the state where a positive pressure is held inside each fluid flow path, the positive pressure shifts into the small ink chambers which correspond to the valve bodies. As a result, in the nozzles which can discharge ink to the small ink chambers which correspond to the open valve bodies, the meniscus in the nozzle may be broken due to the positive pressure that has shifted into the small ink chambers.

### SUMMARY

An object of the present invention is to provide a fluid injection apparatus which can prevent the breakage of the meniscus in a nozzle due to the shift of a positive pressure within the suction pump when the drive motor is rotated in the reverse direction after the completion of the cleaning of the fluid injection head.

According to one aspect of the present invention, a fluid injection apparatus comprising a fluid injection head, a capping member, a tank, a fluid flow path, a drive motor, a suction pump, and a shift preventing apparatus is provided. The fluid injection head has a nozzle forming surface. A nozzle for injecting a fluid onto a target is provided on the nozzle forming surface. The capping member makes contact with the fluid injection head in a state where the fluid can be sucked from the nozzle and includes a cap portion which is formed to receive the fluid. The tank collects and holds the fluid discharged from the fluid injection head via the capping member. The fluid flow path connects the cap portion to the tank. The drive motor is rotatable in both forward and reverse directions. The suction pump sucks the fluid through the inside of the cap portion and the fluid flow path and feeding the fluid toward the tank when the drive motor rotates in the forward direction in the state where the fluid injection head and the capping member make contact with each other. The shift preventing apparatus prevents a positive pressure within the suction pump from shifting into the cap portion by the rotation of the drive motor in the reverse direction when the rotation of said drive motor is switched from the forward direction to the reverse direction.

Other aspects and advantages of the invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a schematic perspective view illustrating an ink jet printer according to a first embodiment;

FIG. 2 is a view illustrating the arrangement of the nozzle columns on a nozzle forming surface;

FIG. 3 is a schematic view illustrating a maintenance apparatus according to the first embodiment;

FIG. 4 is a plan cross sectional view illustrating a suction pump;

FIG. 5 is a schematic view illustrating the maintenance apparatus according to a third embodiment;

FIG. 6 is a schematic view illustrating the configuration of a transmission switching apparatus;

FIG. 7 is a schematic view illustrating the state where the carriage is shifted from the location for the pump to the location for the switching valve;

FIG. 8 is a schematic view illustrating the maintenance apparatus according to a fourth embodiment;

FIG. 9 is a schematic view illustrating the maintenance apparatus according to a fifth embodiment;

FIG. 10 is a schematic view illustrating the maintenance apparatus according to a sixth embodiment;

FIG. 11 is a perspective view illustrating a one-way clutch mechanism and a main portion of the switching valve apparatus according to the sixth embodiment;

FIG. 12 is a schematic view illustrating the one-way clutch mechanism and the main portion of the switching valve apparatus of FIG. 11 as viewed from above;

FIGS. 13A to 13C are cross sectional views along the line 13-13 of FIG. 12;

FIG. 14A is a cross sectional view along the line 14A-14A of FIG. 12, FIG. 14B is a cross sectional view along the line 14B-14B of FIG. 12, FIG. 14C is a cross sectional view along the line 14C-14C of FIG. 12 and FIG. 14D is a cross sectional view along the line 14D-14D of FIG. 12;

FIG. 15 is a timing chart illustrating the relationship between the pressing force of the roller applied to the discharge tube and the timing in which the switching valve apparatus is driven when the drive motor starts rotating in the reverse direction; and

FIG. 16A is a schematic cross sectional view illustrating the state where the discharge tube is flattened, FIG. 16B is a schematic cross sectional view illustrating the state where the discharge tube is returning to its original form, and FIG. 16C is a schematic cross sectional view illustrating the state where the discharge tube has returned to its original form.

### DESCRIPTION OF EXEMPLARY EMBODIMENTS

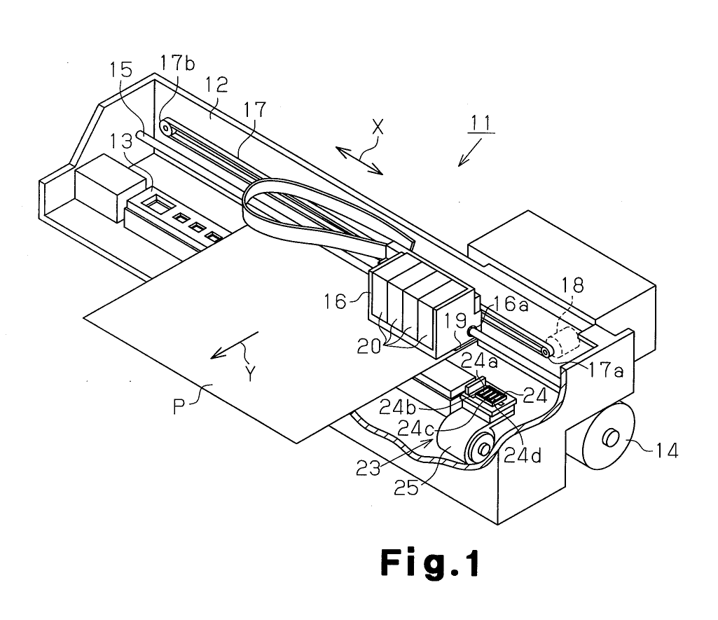

In the following, the ink jet printer as the fluid injection apparatus according to the first embodiment of the present invention is described with reference to FIGS. 1 to 4.

As illustrated in FIG. 1, an inkjet printer 11, which is a fluid injection apparatus, includes a frame 12 in generally rectangular box form. The lower portion within the frame 12 is provided a platen 13 which extends in the main scanning direction X, which is the longitudinal direction of the frame 12. Recording paper P, which is a target, is fed over the platen 13 in the sub-scanning direction Y by a paper feeding mechanism (not shown) when a paper feeding motor 14 which is provided in the lower portion on the back side of the frame 12 (lower portion on rear side in FIG. 1) is driven. The sub-scanning direction Y is perpendicular to the main scanning direction X.

A guide shaft 15 is provided in the longitudinal direction of the platen 13 such a manner as to cross over the plate 13 within the frame 12. A carriage 16 is supported by the guide shaft 15 and can reciprocate in the axial direction of the guide shaft 15 (or the main scanning direction X). Specifically, the guide shaft 15 penetrates through a support hole 16a which is formed through the carriage 16 in the axial direction of the guide shaft 15 and thus the carriage 16 is supported so as to reciprocate in the axial direction of the guide shaft 15.

A drive pulley 17a and a driven pulley 17b are supported in such a manner as to be rotatable in locations corresponding to the opposite end portions of the guide shaft 15 on the inner surface of the rear wall the frame 12 in FIG. 1. The output shaft of the carriage motor 18, which becomes a drive source when the carriage 16 reciprocates, is connected to the drive pulley 17a, and an endless timing belt 17 connected to the carriage 16 is wound around the pair of pulleys 17a and 17b. Accordingly, the carriage 16 can move in the main scanning direction X via the endless timing belt 17 while being guided by the guide shaft 15, by the drive force of the carriage motor 18.

A recording head 19, which is a fluid injection head, is provided on the lower surface of the carriage 16 and a plurality of ink cartridges 20 (four in the present embodiment) for supplying ink, which is a fluid, to the recording head 19 is removably mounted on the carriage 16.

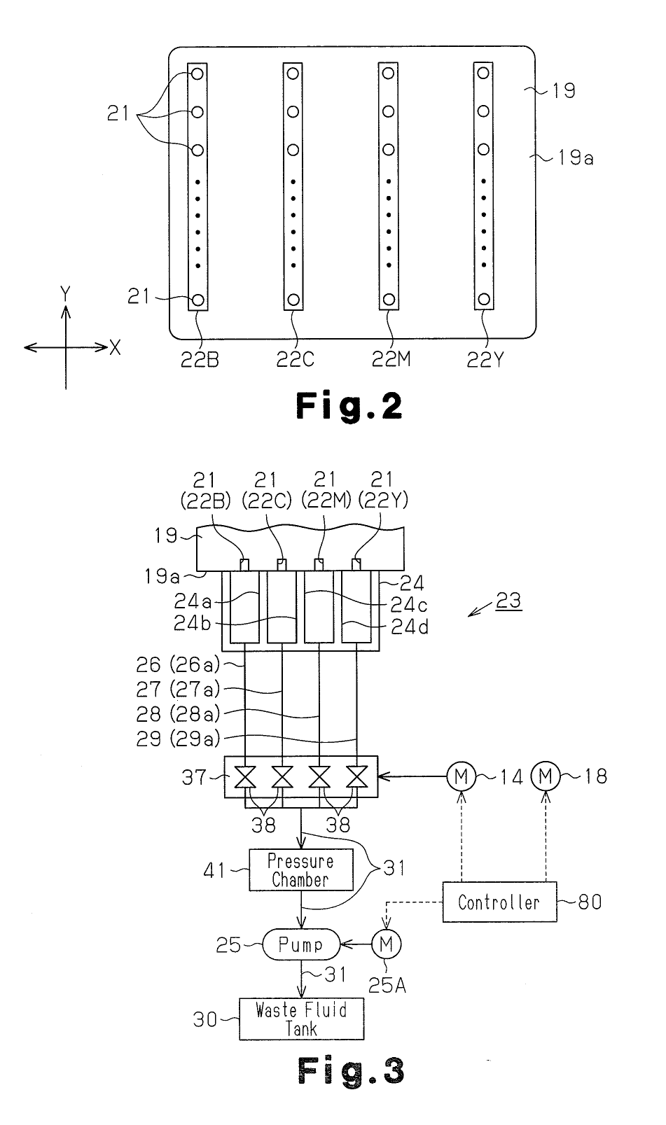

As illustrated in FIG. 2, a black ink nozzle group 22B, a cyan ink nozzle group 22C, a magenta ink nozzle group 22M and a yellow ink nozzle group 22Y, which are nozzle columns extending in the sub-scanning direction Y, are formed of a number of nozzles 21, which comprise discharging holes for discharging ink of each color on the nozzle forming surface 19a, which is the lower surface of the recording head 19. In other words, a plurality of nozzle columns, or a nozzle group 22B, 22C, 22M and 22Y extending in the sub-scanning direction Y, are provided on the nozzle forming surface 19a in such a manner as to form a plurality of regions to be suctioned with constant intervals (nozzle pitch) in the main scanning direction X.

The ink in the ink cartridges 20 is supplied to the recording head 19 from the ink cartridges 20 when the non-illustrated piezoelectric element provided in the recording head 19 is driven, and discharged onto the recording paper P which is fed over the platen 13 from a plurality of nozzles 21 which are formed on the nozzle forming surface 19a of the recording head 19. Thus, printing is carried out.

A maintenance apparatus 23 for maintenance, for example cleaning, of the recording head 19 when printing is not being carried out is provided in the home position region (non-printing region), which does not correspond to recording paper P located in the right end portion in the frame 12 in FIG. 1.

Next, the maintenance apparatus 23 is described below with reference to FIG. 3.

As illustrated in FIG. 3, the maintenance apparatus 23 includes a cap (capping member) 24 and a suction pump 25. The cap 24 is made of a synthetic resin, is in quadrilateral box form with a bottom and an opening on the upper side, and makes contact with the recording head 19 in such a manner as to surround a number of nozzles 21 formed on the nozzle forming surface 19a. The suction pump 25 is driven when the drive motor 25A, which is rotatable in both forward and reverse directions, rotates.

Specifically, the cap 24 is formed in such a manner as to suck the ink from each nozzle 21 of the recording head 19. A plurality of small chambers (four in the present embodiment), i.e., small ink chambers (a first small ink chamber 24a, a second small ink chamber 24b, a third small ink chamber 24c and a fourth small ink chamber 24d in this order from the left in FIG. 3) are formed within the cap 24. The small chambers are cap portions individually corresponding to the nozzle groups 22B, 22C, 22M and 22Y for the respective colors of ink.

The cap 24 is moveable upward and downward by means of an non-illustrated rising and descending apparatus and makes contact with the recording head 19 located in the home position region when risen. In further detail, the surrounding walls forming the first small ink chamber 24a surrounds the individual nozzles 21 forming the black ink nozzle group 22B, the surrounding walls forming the second small ink chamber 24b surrounds individual nozzles 21 forming the cyan ink nozzle group 22C, the surrounding walls forming the third small ink chamber 24c surrounds individual nozzles 21 forming the magenta ink nozzle group 22M, and the surrounding walls forming the fourth small ink chamber 24d surrounds individual nozzles 21 forming the yellow ink nozzle group 22Y.

Flexible discharge tubes 26, 27, 28 and 29, each of which has a discharge path (fluid flow path) 26a, 27a, 28a or 29a created inside, are connected to the respective small ink chambers 24a to 24d of the cap 24. The discharge tubes 26 to 29 merge in the middle and are connected to a waste fluid tank 30 via a suction pump 25. That is to say, one end (upstream side) of the discharge tubes 26 to 29 is connected to small ink chamber 24a to 24d within the cap 24, and the other end (downstream side) is connected to the inside of the waste fluid tank 30. Then, at the time of cleaning or flushing, the ink is discharged through the nozzles 21 into the waste fluid tank 30 via the discharge tubes 26 to 29 (discharge paths 26a to 29a). As used herein, in the following description, “merged discharge tube 31” may refer to a merged portion of the discharge tubes 26 to 29 which extends to the waste fluid tank 30 via the suction pump 25.

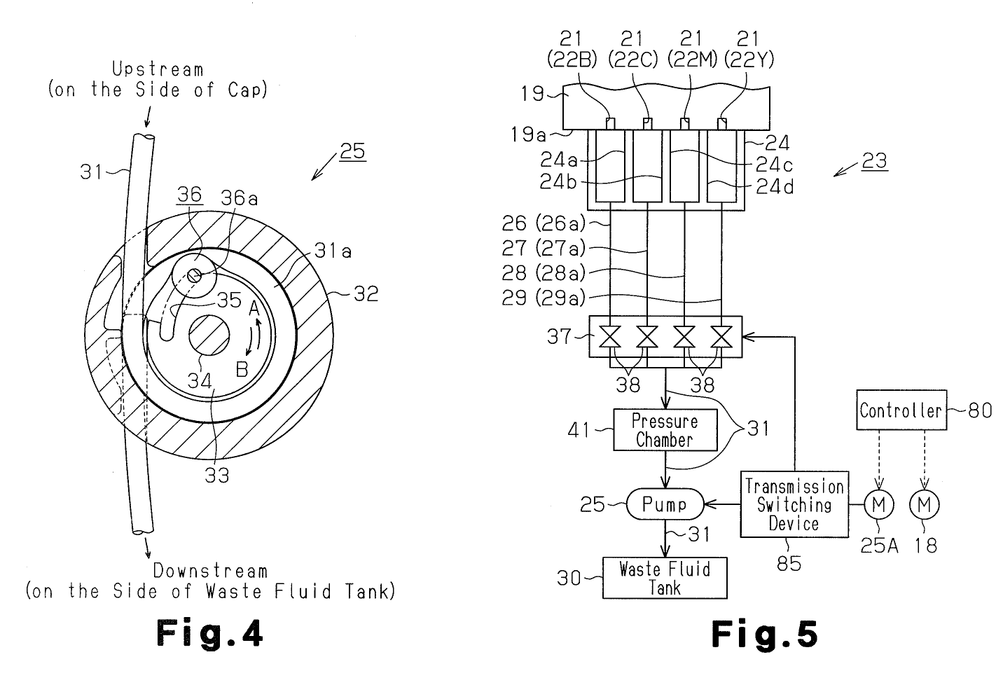

The suction pump 25 includes a cylindrical pump case 32 which is secured to the frame 12, as illustrated in FIG. 4. A pump wheel 33 in circular form in a plan view is contained within the pump case 32 in such a manner as to be rotatable around the wheel shaft 34 provided in the axis core of the pump case 32. A middle portion 31a of the merged discharge tube 31 is contained in the pump case 32 in such a manner as to run along the inner peripheral surface of the pump case 32. The pump wheel 33 rotates in the first rotational direction A when the drive motor 25A rotates in the forward direction, and rotates in the second rotational direction B when the drive motor 25A rotates in the reverse direction.

A guide groove 35 is created in the pump wheel 33 and bulges outward in arc form. The first end of the guide groove 35 is located on the outer peripheral side of the pump wheel 33 and the second end is located on the inner peripheral side of the pump wheel 33. In other words, the guide groove 35 extends inward and further away from the outer peripheral portion of the pump wheel 33 from the first end to the second end. The roller 36 is a pressing member and is supported in such a state that the rotational shaft 36a penetrates through the guide groove 35. The rotational shaft 36a is slidable in the guide groove 35 and the roller 36 is guided along the guide groove 35.

When the pump wheel 33 rotates in the first rotational direction A, the roller 36 moves toward the first end of the guide groove 35 (outer periphery of pump wheel 33). When the pump wheel 33 further rotates in the first rotational direction A, the roller 36 flattens a portion of the middle portion 31a of the merged discharge tube 31 from the upstream side to the downstream side. In other words, when the pump wheel 33 rotates in the first rotational direction A in a state where the cap 24 makes contact with the recording head 19, the pressure inside the merged discharge tube 31 on the upstream side of the suction pump 25 is reduced, which causes negative pressure inside the cap 24 (or small ink chambers 24a to 24d). As a result, the ink having increase viscosity is discharged into the cap 24 together with bubbles from the inside of individual nozzles 21 of the recording head 19 corresponding to the small ink chambers 24a to 24d where negative pressure is generated. Then the discharged ink (waste ink) is discharged into the waste fluid tank 30 via the merged discharge tube 31. Thus, cleaning is carried out.

Meanwhile, when the pump wheel 33 rotates in the second rotational direction B, the roller 36 moves toward the second end of the guide groove 35 (inner periphery of pump wheel 33). As a result of this movement of the roller 36, the pressing force applied to the middle portion 31a of the merged discharge tube 31 by means of the roller 36 become weak in comparison with the case where the pump wheel 33 rotates in the first rotational direction A, and the reduced pressure inside the merged discharge tube 31 is released.

A switching valve apparatus 37 is placed between the cap 24 and the suction pump 25 in the individual discharge paths 26a to 29a. The switching valve apparatus 37 selectively switches the individual discharge paths 26a to 29a between a connected state and a disconnected state when the paper feeding motor 14, which is different from the drive motor 25A, rotates. The switching valve apparatus 37 includes valve bodies 38 which are located in the discharge paths 26a to 29a, respectively. The switching valve apparatus 37 individually opens and closes each valve body 38 as the paper feeding motor 14 rotates so as to bring each discharge path 26a to 29a into a connected state or a disconnected state. Accordingly, in the present embodiment, the paper feeding motor 14 serves as a drive motor for driving the switching valve apparatus 37. A pressure chamber 41 is provided between the switching valve apparatus 37 and the suction pump 25 in the merged discharge tube 31 and stores negative pressure generated from the driving of the suction pump 25.

Next, a control apparatus 80 for controlling the entire inkjet printer 11 is described.

The control apparatus 80 is formed of a non-illustrated digital computer including a CPU, a ROM and a RAM, and a non-illustrated drive circuit for various types of motors 14, 18 and 25A. The ROM stores various types of control programs for controlling the inkjet printer 11 (e.g., cleaning process as described below) in advance. The RAM stores various types of information which can be appropriately rewritten while the inkjet printer 11 is being driven.

Next, among various types of control processes carried out by the control apparatus 80, a cleaning process routine for cleaning from is described. In the cleaning process routine, the control apparatus 80 moves the carriage 16 to a home position region as the carriage motor 18 rotates and makes the cap 24 make contact with the recording head 19 as the non-illustrated rising and descending apparatus is driven. In addition, the control apparatus 80 drives the switching valve apparatus 37 based on the rotation of the paper feeding motor 14. In this case, the valve bodies 38 which correspond to the nozzle group where the ink is desired to be discharged as cleaning is carried out (e.g., the magenta ink nozzle group 22M and the yellow ink nozzle group 22Y) are operated to open, while the valve bodies 38 which correspond to the group where the ink is not desired to be discharged (e.g., the black ink nozzle group 22B and the cyan ink nozzle group 22C) are operated to be closed.

Then, the control apparatus 80 carries out cleaning as the drive motor 25A rotates in the forward direction. When the cleaning is completed, the control apparatus 80 stops the operation of the suction pump 25 by stopping the forward rotation of the drive motor 25A. As used hereinafter, the term “rotation of suction pump 25 in the forward direction” indicates the operation of the suction pump 25 as the drive motor 25A rotates in the forward direction, and the term “rotation of suction pump 25 in the reverse direction” indicates the operation of the suction pump 25 as the drive motor 25A rotates in the reverse direction.

Subsequently, the control apparatus 80 operates all the valve bodies 38 so that they close as the paper feeding motor 14 rotates and then rotates the suction pump 25 in the reverse direction as the drive motor 25A rotates in the reverse direction for a predetermined time. This predetermined time is the time it takes for the pressing force by the roller 36 applied to the merged discharge tube 31 to be eliminated completely as the drive motor 25A is driven so as to rotate in the reverse direction, and set in advance in experiments or simulations. Accordingly, in the present embodiment, the control apparatus 80 and the switching valve apparatus 37 operate all the valve bodies 38 so that they close as the switching valve apparatus 37 is driven when the suction pump 25 stops rotating in the forward direction, and after that, drive the suction pump 25 so that it rotates in the reverse direction. That is, the control apparatus 80 and the switching valve apparatus 37 form a shift preventing apparatus which prevents the positive pressure generated inside the suction pump 25 from shifting into the cap 24 when the drive motor 25A is switched from rotation in the forward direction to rotation in the reverse direction. After that, the control apparatus 80 completes the cleaning process routine.

Next, the working advantages of the inkjet printer 11 according to the present embodiment at the time of the completion of cleaning are described.

After the suction pump 25 stops rotating in the forward direction as the drive motor 25A stops rotating in the forward direction, all the valve bodies 38 are closed as the switching valve apparatus 37 is driven. After that, the suction pump 25 is rotated in the reverse direction as the drive motor 25A, which has been stopping at that point, starts rotating in the reverse direction. In this situation, the rotation of the pump wheel 33 is switched from the first rotational direction A to the second rotational direction B within the suction pump 25 (FIG. 4). However, immediately after the rotation of the pump wheel 33 has switched to the second rotational direction B, the pressing force of the roller 36 applied to a portion of the merged discharge tube 31 is still great. Therefore, the pressed portion is in a flattened state. In other words, the upstream side of the pressed portion and the downstream side of the pressed portion are in a disconnected state within the tube 31.

Therefore, immediately after the pump wheel 33 starts rotating in the second rotational direction B, the positive pressure generated in the suction pump 25 shifts toward the cap 24 from the suction pump 25 through the merged discharge tube 31. As a result, since all the valve bodies 38 have been closed, the positive pressure as described above is stored within the merged discharge tube 31 and within the pressure chamber 41 between the suction pump 25 and the cap 24. As used herein, the term “positive pressure” refers to pressure that is greater than air pressure.

After that, when the suction pump 25 continues to rotation in the reverse direction, the pressing force of the roller 36 applied to the portion of the merged discharge tube 31 gradually becomes smaller and the pressed portion spreads using the elastic resilience of the merged discharge tube 31. In other words, the upstream side and the downside side of the pressed portion become a connected state within the tube 31. Then, the positive pressure stored on the upstream side of the suction pump 25 starts shifting downstream (toward the waste fluid tank 30) within the merged discharge tube 31.

Then, when the pump wheel 33 in the suction pump 25 further rotates in the second rotational direction B and the roller 36 are completely separated from the merged discharge tube 31, the pressing force of the roller 36 applied to the portion of the merged discharge tube 31 is eliminated. Therefore, a cross section of the pressed portion becomes generally circular. Then, the positive pressure stored inside the merged discharge tube 31 is discharged to the outside via the lower flow end of the merged discharge tube 31, and consequently, difference in pressure is eliminated within the respective discharge paths 26a to 29a.

Accordingly, the present embodiment has the following advantages.

(1) When the rotation of the drive motor 25A is switched from the forward direction to the reverse direction, the positive pressure generated inside the suction pump 25 is prevented from shifting into the cap 24 by the valve bodies 38 in a closed state. Accordingly, when the suction pump 25 is rotated in the reverse direction after the completion of cleaning, the breakage of the meniscus inside the nozzle 21 can be prevented.

(2) When the suction pump 25 stops rotating in the forward direction, all the valve bodies 38 are switched to a closed state based on the drive by the switching valve apparatus 37. After that, the suction pump 25 is rotated in the reverse direction. That is, all the valve bodies 38 become a closed state and it is ensured that the positive pressure stored within the merged discharge tube 31 and within the pressure chamber 41 is prevented from shifting into the cap 24.

(3) The drive source of the switching valve apparatus 37 is a paper feeding motor 14 which is different from the drive motor 25A, which is the drive source for the suction pump 25. Therefore, the rotation of the drive motor 25A is not transmitted to the switching valve apparatus 37. Accordingly, it is not necessary to switch the transmission paths for transmitting the rotation of the drive motor 25A to the suction pump 25 or the switching valve apparatus 37, as compared to the case where the drive motor 25A also serves as the drive source of the switching valve apparatus 37. Accordingly, the configuration of the path for transmitting power to the switching valve apparatus 37 can be simplified.

(4) The paper feeding motor 14 serves as the drive source for the switching valve apparatus 37. Therefore, increase in the number of motors used can be prevented, as compared to the case where the drive source for the switching valve apparatus 37 is provided separately from the paper feeding motor 14 and the drive motor 25A.

(5) When the rotation of the drive motor 25A is switched from the forward direction to the reverse direction, the pressing force of the roller 36 applied to the portion of the merged discharge tube 31 gradually decreases. Therefore, the merged discharge tube 31 can be sufficiently protected, as compared to the case where the merged discharge tube 31 is kept pressed by the roller 36 during rotation of the drive motor 25A in the forward direction and rotation in the reverse direction.

(6) The suction pump 25 is rotated in the reverse direction after all the valve bodies 38 placed on the upstream side of the suction pump 25 are switched to a closed state. Therefore, when the pressing pressure of the roller 36 applied to the merged discharge tube 31 is eliminated as the drive motor 25A rotates in the reverse direction, the positive pressure stored between the suction pump 25 and the valve bodies 38 in a closed state within the merged discharge tube 31 can be discharged to the waste fluid tank 30 via the merged discharge tube 31. Accordingly, after that, even when the valve bodies 38 in a closed state are operated to open, flow back of ink or gas into the cap 24 can be prevented.

Next, the second embodiment of the present invention is described. In the second embodiment, the cleaning process routine is different from that of the first embodiment. Accordingly, in the following description, portions which are different from the first embodiment are mainly described and like elements that are the same as or similar to those of the first embodiment are represented by like numerals and the explanation will be omitted.

The cleaning process routine carried out by the control apparatus 80 according to the second embodiment is described. When the suction pump 25 stops rotating in the forward direction as the drive motor 25A rotates in the forward direction in the cleaning process routine, the control apparatus 80 drives the suction pump 25 for rotation in the reverse direction as the drive motor 25A rotates in the reverse direction. When the suction pump 25 continues to rotate in the reverse direction for the predetermined time as described above, the control apparatus 80 stops the suction pump 25 and operates all the valve bodies 38 so that they open as the paper feeding motor 14 rotates. Accordingly, in the present embodiment, the control apparatus 80 and the switching valve apparatus 37 form a shift preventing apparatus which drives the suction pump 25 for rotation in the reverse direction and operates all the valve bodies 38 to open based on the drive of the switching valve apparatus 37, when the suction pump 25 is stopped rotating in the forward direction. After that, the control apparatus 80 completes the cleaning process routine.

In other words, in the present embodiment, after the suction pump 25 is rotated in the reverse direction so that difference in pressure is eliminated within the respective discharge paths 26a to 29a, the switching valve apparatus 37 starts being driven. Therefore, the positive pressure stored within the merged discharge tube 31 and within the pressure chamber 41 on the upstream side of the suction pump 25 shifts to the downstream within the merged discharge tube 31 and is discharged to the waste fluid tank 30. In other words, the shift of the positive pressure from the suction pump 25 to the inside of the small ink chambers (e.g., the first small ink chamber 24a and the second small ink chamber 24b) corresponding to the valve bodies 38 can be prevented. The valve bodies 38 have been switched from a closed state to an open state based on the drive of the switching valve apparatus 37. Accordingly, the breakage of the meniscus in each nozzle 21 that forms a nozzle group (e.g., the magenta ink nozzle group 22M and the yellow ink nozzle group 22Y) which corresponds to the small ink chamber can be prevented.

Accordingly, the second embodiment, in addition to the advantages (1) and (3) to (5) of the first embodiment, has the following advantages.

(7) When the rotation of the drive motor 25A is switched from the forward direction to the reverse direction, the switching valve apparatus 37 stops being driven. During this time, the positive pressure stored between the suction pump 25 and the valve bodies 38 in a closed state within the merged discharge tube 31 is discharged from the liquid waste tank 30. That is, there is a delay between the time when the suction pump 25 starts rotating in the reverse direction and the time when the switching valve apparatus 37 starts being driven, and thus, the shift of the positive pressure into the cap 24 can be prevented when the suction pump 25 is rotated in the reverse direction when the cleaning is completed.

Next, the third embodiment of the present invention is described with reference to FIGS. 5 to 7. The third embodiment is different from the first embodiment in the drive source for the switching valve apparatus 37. Accordingly, in the following description, portions which are different from the first embodiment are mainly described and like elements that are the same as or similar to those of the first embodiment are represented by like numerals and the explanation will be omitted.

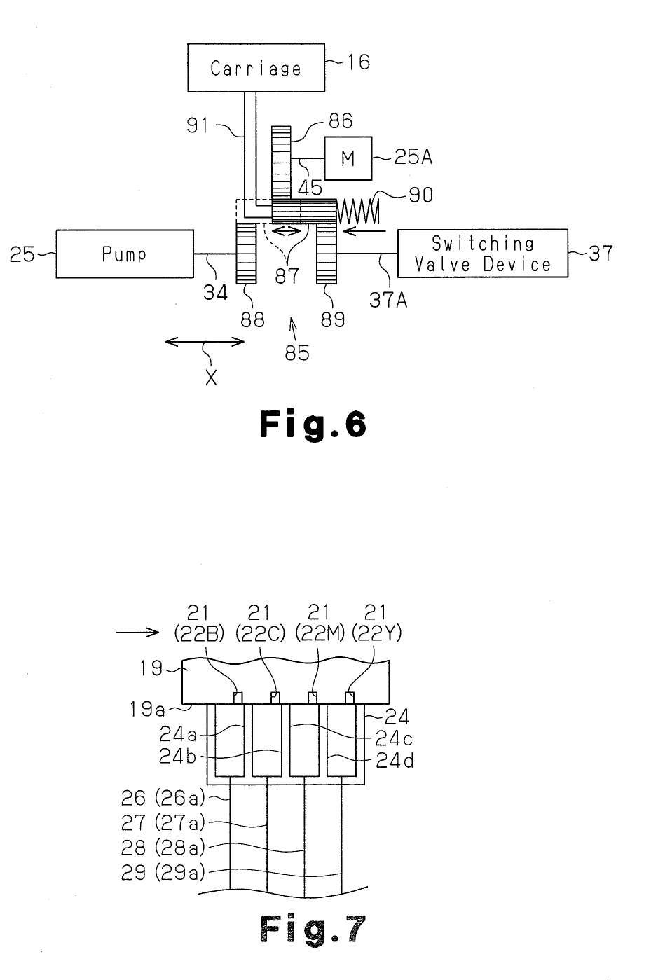

As illustrated in FIG. 5, the switching valve apparatus 37 according to the third embodiment is driven as the drive motor 25A, which is the drive source for the suction pump 25, rotates. A transmission switching apparatus 85 is provided in the transmission path for transmitting the rotation of the drive motor 25A to the suction pump 25 or the switching valve apparatus 37. The transmission switching apparatus 85 switches the transmission paths so that the rotation of the drive motor 25A can be selectively transmitted to the suction pump 25 or the switching valve apparatus 37 as the carriage 16, which is another drive source, moves in the main scanning direction X, as illustrated in FIG. 6.

Next, the configuration of the transmission switching apparatus 85 is described, with reference to FIGS. 6 and 7. As illustrated in FIG. 6, the transmission switching apparatus 85 includes an external cog type motor-side gear 86 and an external cog type transmission gear 87. The motor-side gear 86 is secured to the rotation shaft 45 of the drive motor 25A in such a state that the gear 86 is rotatable around the rotation shaft 45. The transmission gear 87 engages with the motor-side gear 86. The transmission gear 87 is moveable between two locations, a first transmission location (location indicated by a solid line) for transmitting the rotation of the drive motor 25A to the suction pump 25, and a second transmission location (location indicated by a broken line) for transmitting the rotation to the switching valve apparatus 37. The transmission switching apparatus 85 includes an external cog type pump-side gear 88 and an external cog type switching valve-side gear 89. The pump-side gear 88 is secured to the wheel shaft 34 of the suction pump 25 in such a state that the gear 88 is rotatable around the wheel shaft 34. The switching valve-side gear 89 is secured to the rotational shaft 37A of the switching valve apparatus 37 in such a state that the gear is rotatable around the rotational shaft 37A. When the transmission gear 87 is located in the first transmission location, the transmission gear 87 and the pump-side gear 88 engage and the rotation of the drive motor 25A is transmitted to the suction pump 25. Meanwhile, when the transmission gear 87 is located in the second transmission location, the transmission gear 87 and the switching valve-side gear 89 engage and the rotation of the drive motor 25A is transmitted to the switching valve apparatus 37.

The transmission switching apparatus 85 also includes a coil spring 90 and a pressing member 91. The coil spring 90 is a biasing member for biasing the transmission gear 87 toward the first transmission location from the second transmission location. The pressing member 91 is supported by the carriage 16 and presses the transmission gear 87 toward the second transmission location from the first transmission location. When the carriage 16 is located to the left side of FIG. 6 (i.e., the printing region corresponding to recording paper P) relative to the location illustrated in FIG. 5 (hereinafter referred to as “location for the pump”), the transmission gear 87 is located in the first transmission location as a result of the biasing force of the coil spring 90. Meanwhile, when the carriage 16 shifts from the location for the pump to the location illustrated in FIG. 7 (hereinafter referred to as “location for the switching valve”), the transmission gear 87 is pressed to the right in FIG. 6 by the pressing member 91, and as a result, is placed in the second transmission location against the biasing force by the coil spring 90. Accordingly, in the present embodiment, the carriage 16 and the coil spring 90 form the drive source for driving the transmission switching apparatus 85. The individual nozzles 21 that form the nozzle groups 22B, 22C, 22M and 22Y can discharge ink into the corresponding small ink chamber 24a to 24d, even if the carriage 16 shifts to the location for the switching valve, as illustrated in FIG. 7.

Next, the cleaning process routine carried out by the control apparatus 80 is described. In the cleaning process routine, the control apparatus 80 moves the carriage 16 to the location for the switching valve as the carriage motor 18 rotates, and after that, drives the switching valve apparatus 37 as the drive motor 25A rotates. The control apparatus 80 operates the individual valve bodies 38 which correspond to the magenta ink nozzle group 22M and the yellow ink nozzle group 22Y so that they open and operates the valve bodies 38 which correspond to the black ink nozzle group 22B and the cyan ink nozzle group 22C so that they close. In addition, the control apparatus 80 moves the carriage 16 from the location for the switching valve to the location for the pump as the carriage motor 18 rotates, and after that, makes the cap 24 contact with the recording head 19. Subsequently, the control apparatus 80 drives the suction pump 25 for rotation in the forward direction, in order to carry out cleaning.

Then, when the cleaning is completed, the control apparatus 80 stops rotating the suction pump 25 in the forward direction. Subsequently, the control apparatus 80 moves the carriage 16 from the location for the pump to the location for the switching valve as the carriage motor 18 rotates, and operates all the valve bodies 38 to close as the drive motor 25A rotates in this state. Then, the control apparatus 80 temporarily stops the rotation of the drive motor 25A and moves the carriage 16 from the location for the switching valve to the location for the pump as the carriage motor 18 rotates. Then, the control apparatus 80 drives the suction pump 25 for rotation in the reverse direction for the predetermined time. After that, the cleaning process routine is completed.

Accordingly, the third embodiment, in addition to the advantages (1), (2), (5) and (6) of the above embodiments, has the following advantages.

(8) The suction pump 25 and the switching valve apparatus 37 have the same drive source and the transmission switching apparatus 85 selectively switches the transmission paths for selectively transmitting the rotation of the drive motor 25A to the suction pump 25 or the switching valve apparatus 37. Therefore, the operation of the switching valve apparatus 37 can be restricted during the operation of the suction pump 25 without fail as well as the operation of the suction pump 25 can be restricted during the operation of the switching valve apparatus 37. Accordingly, when the suction pump 25 is driven, it is ensured that the valve bodies 38 which are in a closed state can be prevented from being operated to open and the valve bodies 38 which are in an open state can be prevented from being operated to close.

(9) The transmission switching apparatus 85 switches the transmission paths as the carriage 16, which is an essential element for printing the recording paper P that is fed into the frame 12, moves in the main scanning direction X. Therefore, the increase in the number of parts can be prevented, as compared to the case where the drive source of the transmission switching apparatus 85 is provided separately from the carriage 16.

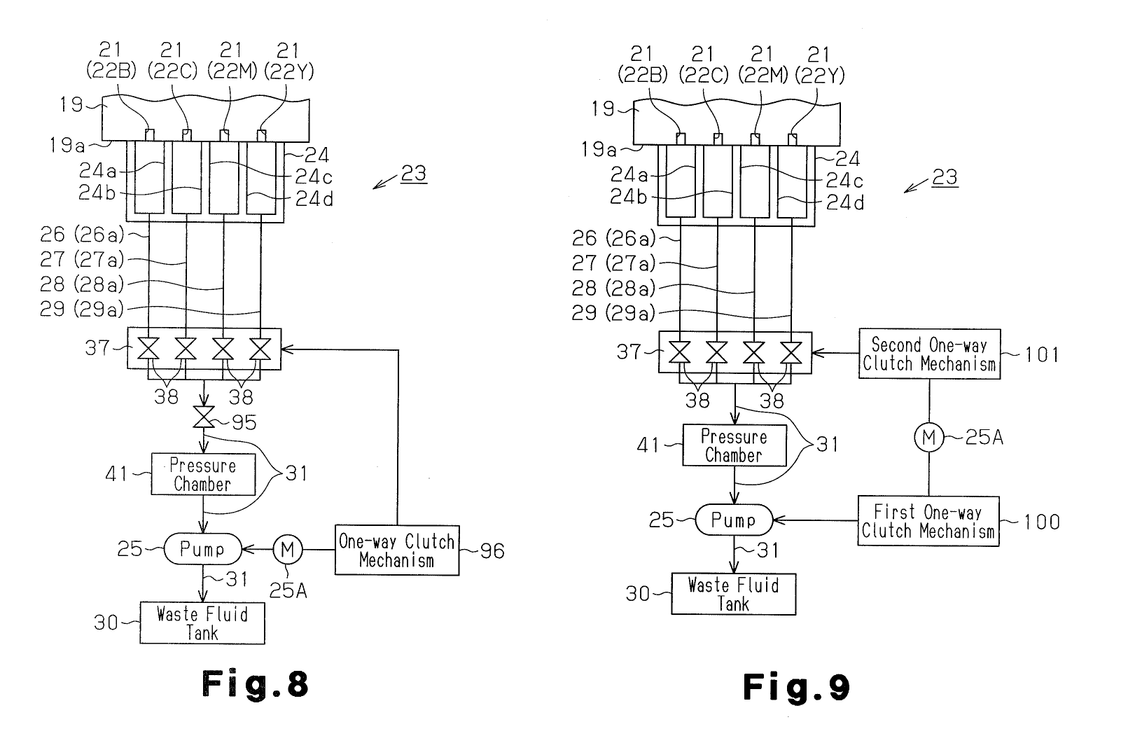

Next, the fourth embodiment of the present invention is described in accordance with FIG. 8. The fourth embodiment is different from the first and second embodiments in that the rotation of the drive motor 25A in the reverse direction is transmitted to the switching valve apparatus 37. Accordingly, in the following description, portions which are different from the first embodiment are mainly described and like elements that are the same as or similar to those of the first and second embodiments are represented by like numerals and the explanation will be omitted.

As illustrated in FIG. 8, a one-way valve 95 is provided between the switching valve apparatus 37 and the pressure chamber 41 in the merged discharge tube 31. The one-way valve 95 is a shift preventing apparatus for allowing ink and gas to move from the cap 24 to the suction pump 25 within the merged discharge tube 31 while preventing ink and gas from moving from the suction pump 25 to the cap 24 within the merged discharge tube 31.

The switching valve apparatus 37 is driven as the drive motor 25A rotates in the reverse direction. Specifically, a one-way clutch mechanism 96 for transmitting only the rotation of the motor 25A in the reverse direction to the switching valve apparatus 37 is provided in the transmission path for transmitting the rotation of the drive motor 25A to the switching valve apparatus 37.

Therefore, when the drive motor 25A rotates in the reverse direction after the suction pump 25 stops rotating in the forward direction during the cleaning, the suction pump 25 is rotated in the reverse direction and the switching valve apparatus 37 is driven. Even when the valve bodies 38, which are in a closed state during the operation of the suction pump 25 for rotation in the forward direction, are operated so that they open during the above operation of the suction pump 25 for rotation in the reverse direction, the positive pressure stored within the merged discharge tube 31 and within the pressure chamber 41 on the upstream side of the suction pump 25 can be prevented from shifting into the cap 24 by means of the one-way valve 95. After that, as a result of further drive of the suction pump 25 for rotation in the reverse direction, difference in pressure is eliminated within the respective discharge paths 26a to 29a.

Accordingly, the fourth embodiment, in addition to the advantage (1) of the above embodiments, has the following advantages.

(10) The one-way valve 95 is placed on the merged discharge tube 31 on the side of the cap 24. Therefore, flow back of ink and gas from the suction pump 25 into the cap 24 can be prevented.

(11) If a one-way valve 95 was placed between the cap 24 and the switching valve apparatus 37, it would be necessary to place the respective one-way valves 95 on the discharge tubes 26 to 29. In this regard, the present embodiment has a configuration where only one one-way valve 95 is placed on the merged discharge tube 31, and therefore, the increase in the number of parts can be prevented.

Next, the fifth embodiment of the present invention is described with reference to FIG. 9. The fifth embodiment is different from the above embodiments particularly in that the suction pump 25 does not rotate in the reverse direction when the cleaning is completed. Accordingly, in the following description, portions which are different from the first embodiment are mainly described and like elements that are the same as or similar to those of the first embodiment are represented by like numerals and the explanation will be omitted.

As illustrated in FIG. 9, according to the present embodiment, only the rotation of the drive motor 25A in the forward direction is transmitted to the suction pump 25 and only the rotation of the drive motor 25A in the reverse direction is transmitted to the switching valve apparatus 37. That is, a first one-way clutch mechanism 100 for transmitting only the rotation of the drive motor 25A in the forward direction to the suction pump 25 is provided in the transmission path for transmitting the rotation of the drive motor 25A to the suction pump 25. A second one-way clutch mechanism 101 for transmitting only the rotation of the drive motor 25A in the reverse direction to the switching valve apparatus 37 is provided in the transmission path for transmitting the rotation of the drive motor 25A to the switching valve apparatus 37.

At the time of cleaning, after the suction pump 25 stop rotating in the forward direction, the drive motor 25A rotates in the reverse direction and thus all the valve bodies 38 are operated so that they close. That is, in the present embodiment, the suction pump 25 does not rotate in the reverse direction, and therefore, the positive pressure generated inside the suction pump 25 when the drive motor 25A rotated in the forward direction does not shift to the cap 24.

Accordingly, the fifth embodiment has the following advantage.

(12) At the time of cleaning, the rotation of the drive motor 25A in the reverse direction is not transmitted to the suction pump 25 after the rotation of the suction pump 25 in the forward direction is stopped. Therefore, the positive pressure generated within the suction pump 25 when the drive motor 25A rotated in the forward direction does not shift to the upstream side from the suction pump 25. Accordingly, the breakage of the meniscus inside the nozzles 21 can be prevented due to shifting of the positive pressure into the cap 24.

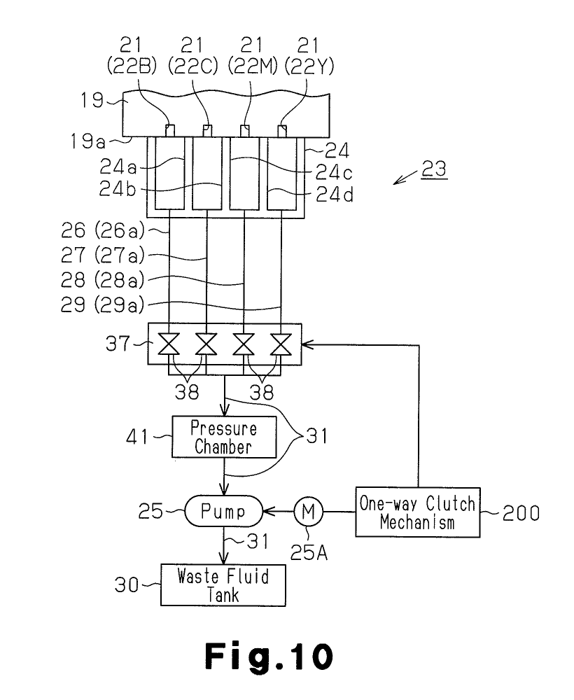

Next, the sixth embodiment of the present invention is described with reference to FIG. 10. In the sixth embodiment, the switching valve apparatus 37 is connected to the drive motor 25A via a one-way clutch mechanism 200 for delaying transmission of the rotation of the drive motor 25A in the reverse direction to the switching valve apparatus 37. Only when the drive motor 25A rotates in the reverse direction, the one-way clutch mechanism 200 transmits the drive force resulting from the rotation to the switching valve apparatus 37.

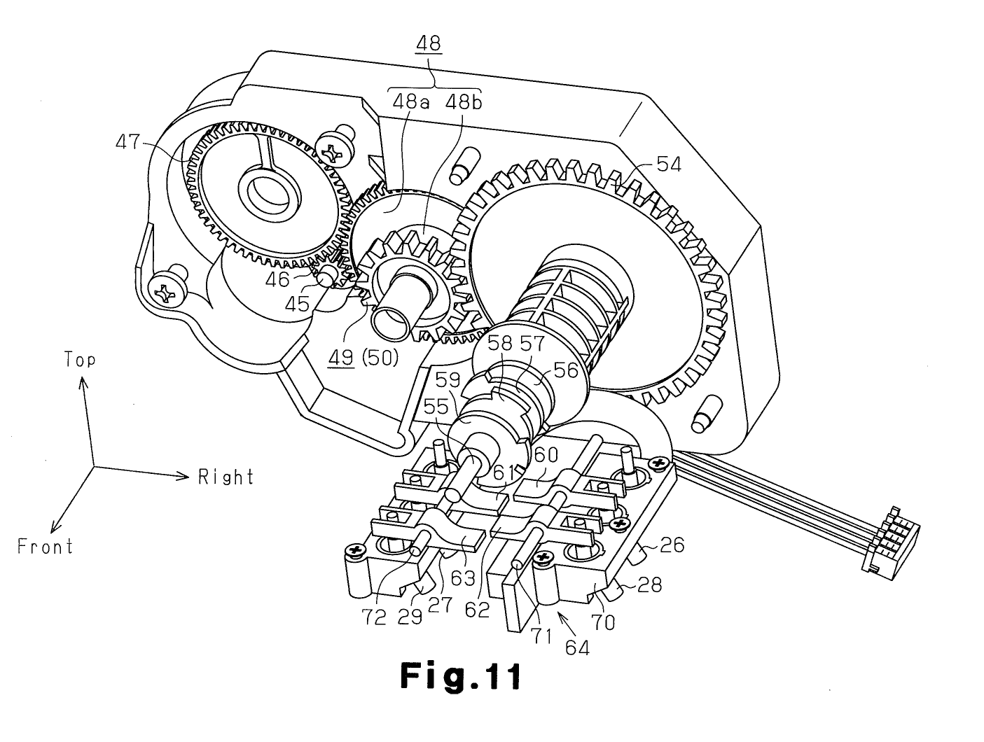

Next, the configuration for transmitting the rotation of the drive motor 25A to the suction pump 25 or the one-way clutch mechanism 200 is described, with reference to FIGS. 11 to 13. In the following description, “front-rear direction,” “left-right direction” and “up-down direction” respectively indicate the front-rear direction, the left-right direction and the up-down direction indicated by the arrows in FIG. 11.

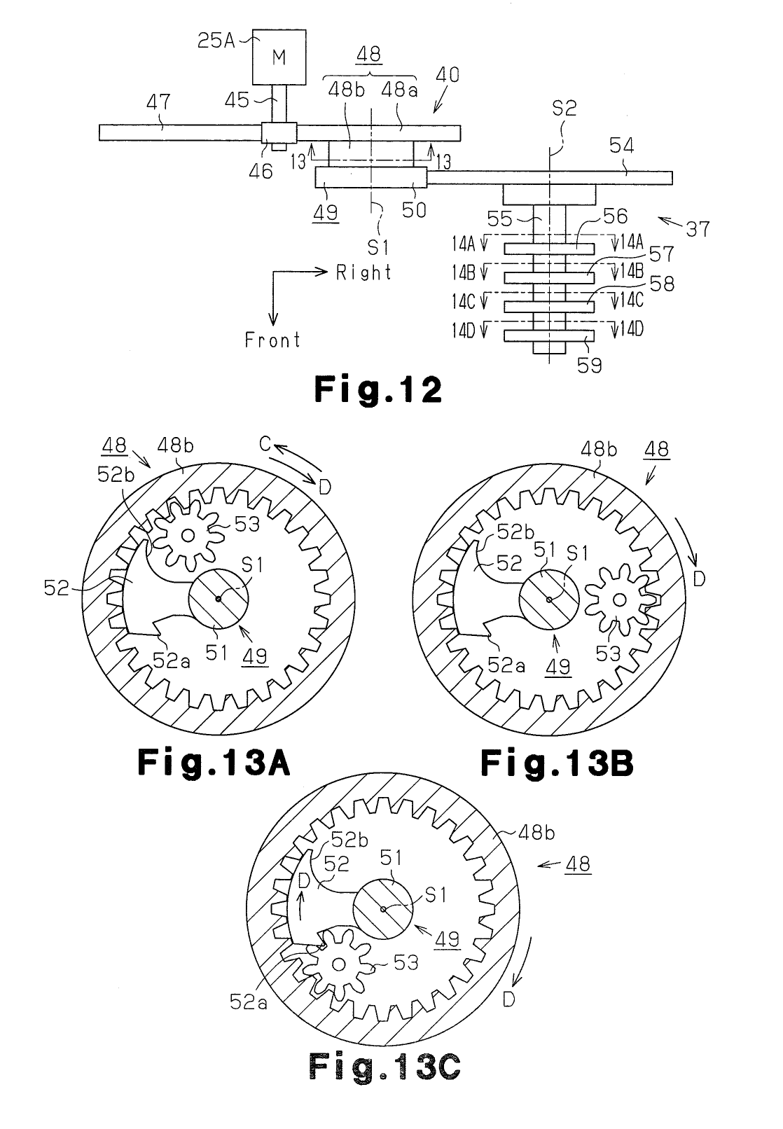

As illustrated in FIGS. 11 and 12, an external cog type motor-side gear 46, which is rotatable around the rotation shaft 45, is secured to the rotation shaft 45 of the drive motor 25A. An external cog type pump-side gear 47 which engages with the motor-side gear 46 is provided on the left of the motor-side gear 46. The wheel shaft 34 of the suction pump 25 (see FIG. 4) is secured in the center portion of the pump-side gear 47 in the radial direction. When the drive motor 25A (and the motor-side gear 46) rotates in the forward direction, the pump-side gear 47 rotates in the first rotational direction A, which is opposite to the forward direction. When the drive motor 25A rotates in the reverse direction, the pump-side gear 47 rotates in the second rotational direction B, which is opposite to the reverse direction.

The one-way clutch mechanism 200 is provided on the right side of the motor-side gear 46. The one-way clutch mechanism 200 includes a first rotational gear 48, which is a first rotational member that is rotatable around the first axis line S1, and a second rotational gear 49, which is a second rotational member that is placed in front of the first rotational gear 48 and rotatable around the first axis line S1. The first rotational gear 48 includes a large diameter gear portion 48a, which is an external cog type formed in such a manner that it can engage with the motor-side gear 46 and a small diameter gear portion 48b, which is an internal cog type gear portion formed so as to have a smaller diameter than the large diameter gear portion 48a. The large diameter gear portion 48a and the small diameter gear portion 48b are integrally formed in an arrangement that the small diameter gear portion 48b is located in front of the large diameter gear portion 48a in the axial direction.

As illustrated in FIGS. 13A to 13C, the small diameter gear portion 48b is in generally cylindrical form and a great number of cogs are formed around its inner periphery at equal intervals along the direction of the circumference. When the drive motor 25A rotates in the forward direction, the first rotational gear 48 rotates in the third rotational direction C, which is opposite to the forward direction. When the drive motor 25A rotates in the reverse direction, the first rotational gear 48 rotates in the fourth rotational direction D, which is opposite to the reverse direction.

As illustrated in FIGS. 11 and 12, the second rotational gear 49 includes the main body 50 of an external cog type. The main body 50 has a smaller diameter than the large diameter gear portion 48a of the first rotational gear 48 and is located in front of the small diameter gear portion 48b of the first rotational gear 48 in the axial direction. As illustrated in FIGS. 13A to 13C, the second rotational gear 49 also includes a cylindrical portion 51 which extends from the center portion of the main body 50 in the radial direction toward the inside of the small diameter gear portion 48b of the first rotational gear 48 (i.e., toward the rear side in the axial direction), and an extended portion 52 in generally fan form which extends from the cylindrical portion 51 toward the rear side in the radial direction within the small diameter gear portion 48b.

The extended portion 52 is formed so that the outer portion in the radial direction of the extended portion 52, or the end surface of the extended portion 52, slides against the end of each internal cog formed on the inner peripheral side of the small diameter gear portion 48b of the first rotational gear 48 when the second rotational gear 49 rotates. The leading portion of the extended portion 52 on the side of the third rotational direction C is a protrusion 52a which protrudes in the third rotational direction C in cog form. The leading portion of the extended portion 52 on the side of the fourth rotational direction D is an arched surface 52b in arc form.

In addition, an external cog type pinion 53 which engages with the small diameter gear portion 48b of the first rotational gear 48 is provided inside the small diameter gear portion 48b in such an arrangement that the pinion 53 can go around the cylindrical portion 51 of the second rotational gear 49 (in other words, around the first axis line S1). The pinion 53 is placed in such a state as to be constantly engaged with the small diameter gear portion 48b of the first rotational gear 48. Therefore, when the first rotational gear 48 rotates, the pinion 53 rotates in the same rotational direction as the first rotational gear 48 around the cylindrical portion 51 of the second rotational gear 49.

Then, when the pinion 53 rotates inside the small diameter gear portion 48b of the first rotational gear 48 in the third rotational direction C, the pinion 53 makes contact with the arched surface 52b of the extended portion 52 of the second rotational gear 49 and rotates while sliding against the arched surface 52b in a disengaged state. That is, when the first rotational gear 48 rotates in the third rotational direction C, the pinion 53 makes contact with the arched surface 52b of the extended portion 52 of the second rotational gear 49, and then, simply rotates in an idle state while sliding against the arched surface 52b in the contact location. Therefore, the rotation of the first rotational gear 48 is not transmitted to the second rotational gear 49.

Meanwhile, when the first rotational gear 48 rotates in the fourth rotational direction D, as illustrated in FIG. 13B, the pinion 53 is separated from the arched surface 52b of the extended portion 52 of the second rotational gear 49 and rotates in the fourth rotational direction D within the small diameter gear portion 48b of the first rotational gear 48. Then, when the first rotational gear 48 further rotates in the fourth rotational direction D, as illustrated in FIG. 13C, an external cog of the pinion 53 and the protrusion 52a of the extended portion 52 of the second rotational gear 49 engage. That is, the pinion 53 and the extended portion 52 of the second rotational gear 49 become engaged. When the first rotational gear 48 further rotates in the fourth rotational direction D in this state, the rotation of the first rotational gear 48 in the fourth rotational direction D is transmitted to the second rotational gear 49 via the pinion 53, and thus, the second rotational gear 49 starts rotating in the fourth rotational direction D. The main body 50 of the second rotational gear 49 has a smaller diameter than the large diameter gear portion 48a of the first rotational gear 48. Therefore, the rotation of the drive motor 25A in the reverse direction is transmitted to the switching valve apparatus 37 in such a state that the speed is reduced.

Then, when the second rotational gear 49 rotates in the fourth rotational direction D, as illustrated in FIGS. 11 and 12, the rotation of the drive motor 25A is transmitted to the rotational gear 54 on the valve body side via the second rotational gear 49 because the main body 50 of the second rotational gear 49 engages with the rotational gear 54, which is placed on the right side of the second rotational gear 49 and located on the side of the valve body 38 of the switching valve apparatus 37. That is, when the rotation of the drive motor 25A is switched from the forward direction to the reverse direction, transmission of the rotation of the drive motor 25A to the rotational gear 54 is prevented until the pinion 53 and the extended portion 52 of the second rotational gear 49 become engaged after the pinion 53 starts rotating in the fourth rotational direction D within the small diameter gear portion 48b of the first rotational gear 48. Accordingly, in the present embodiment, the first rotational gear 48, the second rotational gear 49 and the pinion 53 is an apparatus for delaying the transmission of the rotation of the drive motor 25A in the reverse direction to the rotational gear 54 (switching valve apparatus 37) when the rotation of the drive motor 25A is switched from the forward direction to the reverse direction, and at the same time, form a shift preventing apparatus which prevents positive pressure generated inside the suction pump 25 due to the delay of the transmission from shifting into the cap 24.

In the present embodiment, when the pinion 53 and the extended portion 52 of the second rotational gear 49 become engaged because the drive motor 25A starts rotating in the reverse direction, the merged discharge tube 31 is no longer pressed by the roller 36 in the suction pump 25 at that time point. That is, the cross section of the portion in the merged discharge tube 31 pressed by the roller 36 returns to generally circular form due to the elastic resilience of the merged discharge tube 31.

Next, the configuration for operating the individual valve bodies 38 in the switching valve apparatus 37 is described, with reference to FIGS. 11, 12 and 14A to 14C. As illustrated in FIGS. 11 and 12, the switching valve apparatus 37 includes a rotational gear 54 which engages with the second rotational gear 49, as described above, and the rotational gear 54 is rotatable around the second axis line S2. A cam shaft 55 is secured to the rotational gear 54 and extends from the center portion toward the front in the radial direction is secured to the rotational gear 54. The cam shaft 55 rotates around the second axis line S2 together with the rotational gear 54. A plurality of cam members 56, 57, 58 and 59 (four in the present embodiment) are secured to the cam shaft 55 at equal intervals in the direction in which the cam shaft 55 extends. Specifically, the respective cam members 56 to 59 are arranged in order in such a manner that the first cam member 56 is placed on the rear side so as to be closest to the rotational gear 54 and the fourth cam member 59 is placed on the forefront side. A lever portion 64 for the switching valve apparatus 37 is provided beneath the cam shaft 55. The lever portion 64 has levers 60, 61, 62 and 63 which correspond to the respective cam members 56 to 59.

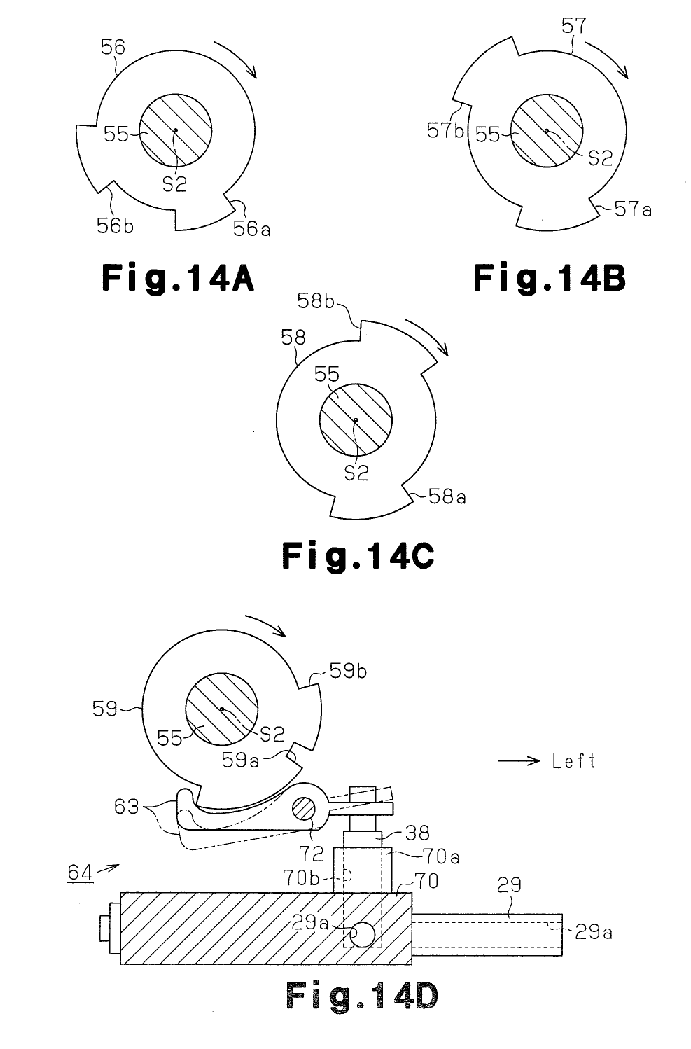

As illustrated in FIG. 14A, the first cam member 56 includes a first protrusion 56a for collective operation and a second protrusion 56b for single operation, which are both in fan form in a cross section. The first protrusion 56a and the second protrusion 56 are formed at an interval of approximately 270 degrees in the direction opposite to the direction in which the cam shaft 55 rotates (counterclockwise direction in FIG. 14A, same in the following). As illustrated in FIG. 14B, the second cam member 57 includes a first protrusion 57a for collective operation and a second protrusion 57b for single operation, which are both in fan form in a cross section. The first protrusion 57a and the second protrusion 57b are formed at an interval of approximately 200 degrees in the direction opposite to the direction in which the cam shaft 55 rotates. As illustrated in FIG. 14C, the third cam member 58 includes a first protrusion 58a for collective operation and a second protrusion 58b for single operation, which are both in fan form in a cross section. The first protrusion 58a and the second protrusion 58b are formed at an interval of approximately 140 degrees in the direction opposite to the direction in which the cam shaft 55 rotates. As illustrated in FIG. 14D, the fourth cam member 59 includes a first protrusion 59a for collective operation and a second protrusion 59b for single operation, which are both in fan form in a cross section. The first protrusion 59a and the second protrusion 59b are formed at an interval of approximately 80 degrees in the direction opposite to the direction in which the cam shaft 55 rotates.

The first protrusions 56a to 59a and the second protrusions 56b to 59b are generally formed in fan form with a center angle in a range from 45 degrees to 75 degrees, though there is a slight difference among the respective protrusions. In addition, the first protrusions 56a to 59a are in the same location in the circumferential direction with the second axis line S2 at the center. The respective second protrusions 56b to 59b are in different locations in the circumferential direction with the second axis line S2 at the center.

The lever portion 64 independently drives each of the valve bodies 38 of the switching valve apparatus 37 so that the each of the discharge paths 26a to 29a becomes a connected or disconnected state as the corresponding one of the cam members 56 to 59 rotates. As illustrated in FIG. 11, the lever portion 64 includes a base 70 in block form, and two rotational shafts 71 and 72 are arranged above the base 70, parallel to the cam shaft 55 at an interval which is greater than the diameter of each of the cam members 56 to 59. The discharge paths 26a to 29a are generated inside the base 70.

The first lever 60 and the third lever 62 are attached to the right rotational shaft 71 in this order from the rear side in FIG. 11 so as to be individually rotatable. The second lever 61 and the fourth lever 63 are attached to the left rotational shaft 72 in this order from the rear side in FIG. 11 so as to be individually rotatable.

The first lever 60 is located beneath the first cam member 56 so as to correspond to the discharge path 26a (and the first small ink chamber 24a), and switches the discharge path 26a between a connected state and a disconnected state as the first cam member 56 rotates. The second lever 61 is located beneath the second cam member 57 so as to correspond to the discharge path 27a (and the second small ink chamber 24b), and switches the discharge path 27a between a connected state and a disconnected state as the second cam member 57 rotates. The third lever 62 is located beneath the third cam member 58 so as to correspond to the discharge path 28a (and the third small ink chamber 24c), and switches the discharge path 28a between a connected state and a disconnected state as the third cam member 58 rotates. The fourth lever 63 is located beneath the fourth cam member 59 so as to correspond to the discharge path 29a (and the fourth small ink chamber 24d), and switches the discharge path 29a between a connected state and a disconnected state as the fourth cam member 59 rotates.

As illustrated in FIG. 14D, a valve body supporting portion 70a is formed in a location which corresponds to the left end of the fourth lever 63 (right end in FIG. 14D) so as to protrude upward on the upper surface side of the base 70 in the lever portion 64. A valve body supporting hole 70b which penetrates through the base 70 to the discharge path 29a is generated in the valve supporting portion 70a. An elongate valve body 38 is placed in the valve body supporting hole 70b such a manner as to be moveable upward and downward in the hole 70b. The valve body 38 is biased down by a non-illustrated coil spring and the lower portion of the valve body 38 always seals the discharge path 29a, making the fourth small ink chamber 24d and the suction pump 25 in a disconnected state.

When the first protrusion 59a or the second protrusion 59b presses down the fourth lever 63 as the fourth cam member 59 rotates, the fourth lever 63 rotates in the clockwise direction in FIG. 14D so that the right end side (left end side in FIG. 14D) of the fourth lever 63 is pressed down. Then, the valve body 38 is opened, and then, the discharge path 29a for connecting the fourth small ink chamber 24d and the suction pump 25 becomes a connected state. That is, the valve body 38 becomes an open state when the first protrusion 59a or the second protrusion 59b presses down the right end side of the fourth lever 63. The configuration where the discharge paths 26a to 28a are switched between a connected state and a disconnected state via the respective levers 60 to 62, to which the cam members 56 to 58 other than the fourth cam member 59 correspond, is substantially the same. Accordingly, detailed explanation thereof is omitted.

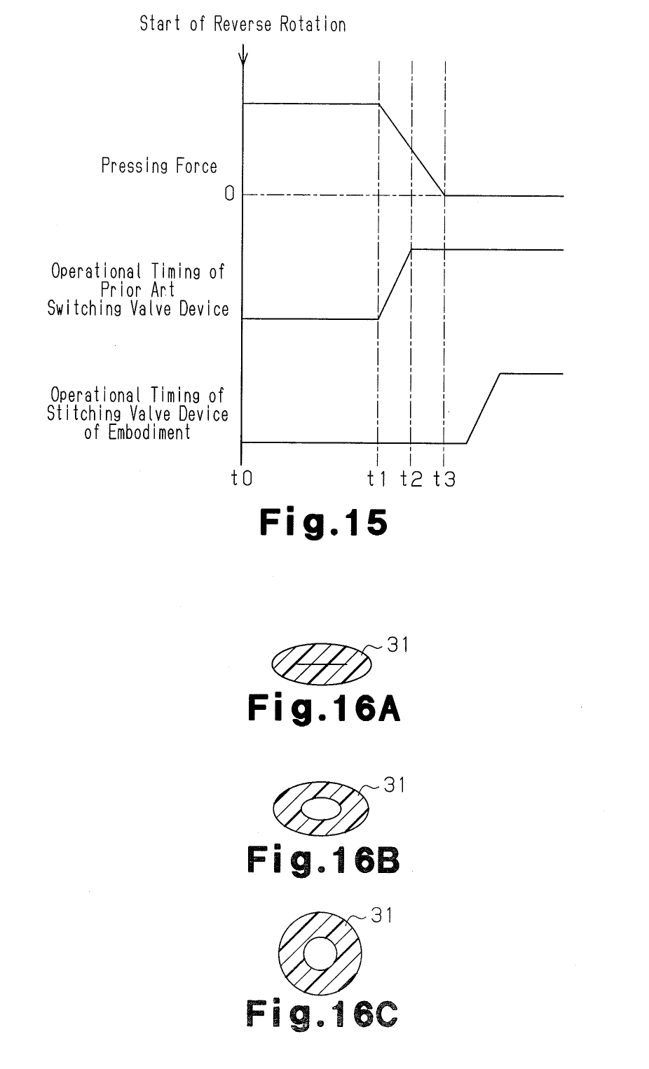

Next, the operations of the present embodiment when cleaning is carried out and when cleaning is completed are described, with reference to FIGS. 15 and 16. It is assumed that when cleaning is carried out, the valve body 38 which corresponds to the magenta ink nozzle group 22M and the valve body 38 which corresponds to the yellow ink nozzle group 22Y are in a closed state.

As described above, when cleaning is carried out, the pump wheel 33 of the suction pump 25 rotates in the first rotational direction A as the drive motor 25A rotates in the forward direction (FIG. 4). Then, the roller 36 move outward along the roller guide groove 35 in the radial direction, and thus, a portion of the merged discharge tube 31 is pressed by the roller 36. Then, the pump wheel 33 rotates in the first rotational direction A in this state.

Then, the pressure is reduced inside the merged discharge tube 31 on the upstream side of the suction pump 25, and negative pressure is generated inside the small ink chambers 24c and 24d, which correspond to the valve bodies 38 in an open state from among the small ink chambers 24a to 24d. As a result, the ink is discharged into the small ink chambers 24c and 24d through the respective nozzles 21 of the nozzle groups 22C and 22B, which correspond to the small ink chambers 24c and 24d, and the thus discharged ink is discharged into the waste fluid tank 30 via the discharge paths 28a and 29a. In this case, the valve bodies 38 which correspond to the nozzle groups 22M and 22Y are in a closed state, and therefore, no ink is discharged through the respective nozzles 21 of the nozzle groups 22M and 22Y.

In the one-way clutch mechanism 200, the first rotational gear 48 rotates in the third rotational direction C. Accordingly, the pinion 53 rotates within the small diameter gear portion 48b of the first rotational gear 48 in the third rotational direction C and makes contact with the arched portion 52b of the extended portion 52 of the second rotational gear 49. Then, the pinion 53 rotates while sliding against the arched surface 52b in a disengaged state, i.e., in an idle state. Therefore, the rotation of the drive motor 25A is not transmitted to the second rotational gear 49. Accordingly, the switching valve apparatus 37 is not driven when the drive motor 25A rotates in the forward direction.

Meanwhile, when cleaning is completed, the rotation of the drive motor 25A is switched from rotation in the forward direction to rotation in the reverse direction. Then, the rotation of the pump wheel 33 is switched from the first rotational direction A to the second rotational direction B within the suction pump 25. As described above and illustrated in FIG. 15, however, immediately after the rotation of the pump wheel 33 is switched to the second rotational direction B (time t0 in FIG. 15), the pressing force of the roller 36 applied to the portion of the merged discharge tube 31 is still great. Therefore, as illustrated in FIG. 16A, the pressed portion is in a flattened state. In other words, the upstream side and the downside side of the pressed portion are in a disconnected state within the tube 31. Therefore, immediately after the rotation of the pump wheel 33 starts in the second rotational direction B, positive pressure generated in the suction pump 25 shifts toward the cap 24 from the suction pump 25 within the merged discharge tube 31.

In the one-way clutch mechanism 200, when the rotation of the drive motor 25A is switched to the reverse direction from the forward direction, the rotation of the first rotational gear 48 is switched from rotation in the third rotational direction C to rotation in the fourth rotational direction D. Then, the pinion 53, which have made contact with the arched surface 52b of the extended portion 52 of the second rotational gear 49 within the small diameter gear portion 48b of the first rotational gear 48, is separated from the arched surface 52b of the extended portion 52 and starts rotating in the fourth rotational direction D within the small diameter gear portion 48b of the first rotational gear 48 (see FIG. 13B).

When the time elapsed after the rotation of the drive motor 25A in the reverse direction starts exceeds time t1, the pressing force of the roller 36 applied to the portion of the tube 31 gradually starts decreasing. Then, when the elapsed time exceeds time t2, as illustrated in FIG. 16B, the pressed portion expands due to the elastic resilience of the merged discharge tube 31. That is, the upstream side and the downside side of the pressed portion become a connected state within the tube 31. It should be noted that, in this state, the pinion 53 is rotating within the small diameter gear portion 48b of the first rotational gear 48 and has not yet engaged with the extended portion 52 of the second rotational gear 49.

When the pressed portion becomes the state illustrated in FIG. 16B, the positive pressure stored on the upstream side of the suction pump 25 within the merged discharge tube 31 starts shifting to the downstream side, i.e., toward the waste fluid tank 30. Then, when the elapsed time exceeds time t3, the roller 36 are completely separated from the merged discharge tube 31 by the further rotation of the pump wheel 33 in the second rotational direction B within the suction pump 25 and the pressing force of the roller 36 applied to the portion of the merged discharge tube 31 is eliminated. Therefore, the pressed portion becomes a generally circular form in a cross section, as illustrated in FIG. 16C. Then, the positive pressure stored within the merged discharge tube 31 is released to the outside via the downstream end of the tube 31, and as a result, difference in pressure is eliminated within the respective discharge paths 26a to 29a.

As described above, when the elapsed time exceeds time t3, the pinion 53 becomes engaged with the extended portion 52 of the second rotational gear 49 within the small diameter gear portion 48b of the first rotational gear 48 and the rotation of the drive motor 25A in the reverse direction is transmitted to the switching valve apparatus 37 via the first rotational gear 48, the pinion 53 and the second rotational gear 49. Then, the switching valve apparatus 37 starts being driven. That is, there is a delay between the time when the pump wheel 33 in the suction pump 25 starts rotating in the second rotational direction B and the time when the switching valve apparatus 37 starts being driven.

That is, after the difference in pressure within the respective discharge paths 26a to 29a is eliminated, the switching valve apparatus 37 starts being driven. Therefore, the positive pressure stored within the merged discharge tube 31 is prevented from shifting into the small ink chambers 24a and 24b, which correspond to the valve bodies 38 that have been open as a result of the drive of the switching valve apparatus 37. Accordingly, the breakage of the meniscus in each nozzle 21 that forms the nozzle groups 22M and 22Y which correspond to the small ink chambers 24a and 24b can be prevented due to the positive pressure shifting into the small ink chambers 24a and 24b.

Accordingly, the sixth embodiment has the following advantages.

(13) In the present embodiment, when the rotation of the drive motor 25A is switched from the forward direction to the reverse direction, the rotation of the drive motor 25A in the reverse direction is transmitted to the switching valve apparatus 37 after a delay. The delay is caused by the one-way clutch mechanism 200 that forms a delay apparatus, more specifically, the first rotational gear 48, the second rotational gear 49 and the pinion 53 of the mechanism 200. That is, during the delay of the transmission of power to the switching valve apparatus 37 caused by the delay apparatus, the positive pressure stored between the suction pump 25 and the valve bodies 38 in a closed state in the discharge paths 26a to 29a is discharged from the waste fluid tank 30 as the drive motor 25a rotates in the reverse direction. Accordingly, the breakage of the meniscus in the nozzles 21 can be prevented when the suction pump 25 is rotated in the reverse direction after the completion of cleaning of the recording head 19.

(14) When the rotation of the drive motor 25A is switched from the forward direction to the reverse direction, the rotation of the drive motor 25A in the reverse direction is transmitted to the switching valve apparatus 37 after the pressing force of the roller 36 applied to the portion of the merged discharge tube 31 becomes lower than the pressing force when the drive motor 25A rotates in the forward direction. That is, the switching valve apparatus 37 starts being driven after the upstream side and the downside side of the portion pressed by the roller 36 in the merged discharge tube 31 become a connected state. Therefore, the positive pressure stored between the suction pump 25 and the valve bodies 38 in a closed state in the discharge paths 26a to 29a can be discharged from the waste fluid tank 30 instead of from the cap 24.

(15) Furthermore, in the present embodiment, the first rotational gear 48, the second rotational gear 49 and the pinion 53 are formed in such a manner that the switching valve apparatus 37 is driven after the pressing force of the roller 36 applied to the portion of the merged discharge tube 31 is completely eliminated, i.e., after the cross section of the pressed portion returns to a generally circular form. Accordingly, the discharge of the positive pressure from the cap 24 can be effectively prevented. Therefore, the increase in the number of parts can be prevented, as compared to the case where the one-way clutch mechanism 200 and the delay apparatus are formed separately.

(16) When the rotation of the drive motor 25A is switched from the forward direction to the reverse direction, the pinion 53 rotates in the fourth rotational direction D around the first axis line S1 and the transmission of the rotation of the drive motor 25A to the switching valve apparatus 37 is delayed until the pinion 53 and the protrusion 52 of the extended portion 52 of the second rotational gear (second rotational member) 49 become engaged. Therefore, the delay apparatus can be miniaturized, as compared to the case where the delay apparatus is formed by providing a drive source other than the drive motor 25A.

(17) The pinion 53 and the extended portion 52 of the second rotational gear 49 are respectively placed within the small diameter gear portion 48b of the first rotational gear 48. Accordingly, the one way clutch mechanism 200 can be miniaturized, as compared to the case where the pinion 53 and the extended portion 52 are placed outside the first rotational gear 48.

(18) The main body 50 of the second rotational gear 49 has a smaller diameter than the large diameter gear portion 48a of the first rotational gear 48. Therefore, the rotation of the drive motor 25A in the reverse direction is transmitted to the rotational gear 54 in such a state that the speed is reduced by the second rotational gear 49. As a result, the drive of the switching valve apparatus 37 can be delayed. This configuration also contributes to release of the above describe positive pressure stored within the discharge paths 26a to 29a into the waste fluid tank 30.

The above embodiments may be modified as follows.

In the fifth embodiment, the motor for driving the switching valve apparatus 37 may be different from the drive motor 25A for driving the suction pump 25. In this configuration, it is desirable for the dedicated motor for the switching valve apparatus 37 to be rotated so as to drive the switching valve apparatus 37 after the suction pump 25 stops rotating in the forward direction as the drive motor 25A rotates in the forward direction. Furthermore, when the drive source for the switching valve apparatus 37 is different from the drive source for the suction pump 25, the first one-way clutch mechanism 100 and the second one-way clutch mechanism 101 may be omitted.

The drive motor 25A may be a motor which is rotatable only in the forward direction.

In the above embodiments, the suction pump 25 may be any type of pump (e.g., a gear pump), as long as it can create negative pressure relative to air pressure in the respective small ink chambers 24a to 24d of the cap 24 when the drive motor 25A rotates in the forward direction.

In the fourth embodiment, the one-way valve 95 may be placed between the pressure chamber 41 and the suction pump 25 in the merged discharge tube 31. In addition, the one-way valves 95 may respectively be placed between the valve bodies 38 and the small ink chambers 24a to 24d in the respective discharge tubes 26 to 29.

In the third embodiment, the transmission switching apparatus 85 may be formed in such a manner as to be drivable based on the vertical movement of the cap 24. In this case, a pressing member which corresponds to the pressing member 91 may be provided in the cap 24. Thus, when the cap 24 moves downward, for example, the gear 87 for transmission may be moved from the first transmission location to the second transmission location by means of the pressing force of the pressing member. This configuration has the same operation and advantages as in the third embodiment.

Air release valves for releasing the inside of the small ink chambers 24a to 24d to the air may be provided in the respective small ink chambers 24a to 24d. In this case, it is desirable to move the other drive source (e.g., carriage 16) in order to move the transmission gear 87 from the first transmission location to the second transmission location after the respective small ink chambers 24a to 24d are opened to the air through operation for opening the respective air release valves by stopping the rotation of the suction pump 25 in the forward direction.

In the third embodiment, when the drive motor 25A stops rotating in the forward direction, the drive motor 25A may rotate in the reverse direction, so that difference in pressure is eliminated within the respective discharge paths 26a to 29a. After that, the transmission gear 87 may be moved from the first transmission location to the second transmission location and the switching valve apparatus 37 may be driven. This configuration has the same operation and advantages as in (1) and (5) to (7).

In the first and second embodiments, the motor for driving the switching valve apparatus 37 may be a dedicated motor for the switching valve apparatus 37 which is different from the paper feeding motor 14 and the drive motor 25A. In this configuration, the recording paper P can be conveyed and the switching valve apparatus 37 can be driven at the same time. Furthermore, when a dedicated motor for the switching valve apparatus 37 is provided, the paper feeding motor 14 may function as the drive motor 25A.

In the sixth embodiment, a configuration which allows all the valve bodies 38 to be in a closed state may be provided. Specifically, all the valve bodies 38 may be switched to a closed state after the completion of cleaning of the recording head 19, and after that, the drive motor 25A may be rotated in the reverse direction. In this case, the breakage of the meniscus in all the nozzles can be prevented.

In the sixth embodiment, the one-way clutch mechanism 200 may be formed in such a manner that a portion of the pinion 53 is located outside the first rotational gear 48 in the axial direction. In this case, the extended portion 52 of the second rotational gear 49 can be located outside the first rotational gear 48.

In the sixth embodiment, the first rotational gear 48 may have any form, as long as the gear 48 includes a portion which engages with the motor-side gear 46 (corresponding to the large diameter gear portion 48a) and a portion which engages with the pinion 53 (corresponding to the small diameter gear portion 48b). For example, the diameter of the large diameter gear portion 48a and the diameter of the small diameter gear portion 48b may be the same. Also in this configuration, the transmission of the rotation of the drive motor 25A in the reverse direction to the switching valve apparatus 37 can be delayed when rotation of the drive motor 25A is switched from the forward direction to the reverse direction.

In the sixth embodiment, the diameter of the main body 50 of the second rotational gear 49 may be the same as or greater than that of the large diameter gear portion 48a of the first rotational gear 48. This configuration also has the same advantages as in (13) to (18).

In the sixth embodiment, the one-way clutch mechanism 200 may have a configuration for restricting the rotation of the second rotational gear 49 when the drive motor 25A rotates in the forward direction instead of a configuration where the rotation of the drive motor 25A in the forward direction is not transmitted to the second rotational gear 49.

In the sixth embodiment, the delay apparatus may be provided separately from the one-way clutch mechanism 200. A speed reducing mechanism, for example, may be provided between the second rotational gear 49 and the rotational gear 54 so that the transmission speed of the rotation of the drive motor 25A via the second rotational gear 49 is reduced in the speed reducing mechanism. In this case, the speed reducing mechanism serves as the delay apparatus.

In the sixth embodiment, the one-way clutch mechanism 200 may be formed in such a manner that the rotation of the drive motor 25A in the reverse direction is transmitted to the switching valve apparatus 37 when the portion pressed by the roller 36 in the merged discharge tube 31 becomes the state illustrated in FIG. 16B after the rotation of the drive motor 25A is switched from the forward direction to the reverse direction. This configuration also has the same advantages as in (13) and (14).

In the sixth embodiment, the paper feeding motor 14 may function as the drive motor 25A. In other words, the suction pump 25 and the one-way clutch mechanism 200 may be driven when the paper feeding motor 14 rotates.

In the above embodiments, the pressure chamber 41 placed on the merged discharge tube 31 may be omitted.

In the above embodiments, if a plurality of ink cartridges 20 other than four (e.g., six) is mounted in the carriage 16, it is desirable for the recording head 19 to have a plurality of nozzle columns other than four (e.g., six), depending on the type of ink. In this case, it is desirable for the cap 24 to be divided into a plurality of small ink chambers other than four (e.g., six) in accordance with the nozzle columns.

In the above embodiments, the capping member may have a plurality of caps (cap portions) corresponding to the respective nozzle columns.

In the above embodiments, the cap 24 does not need to make contact with the periphery on the lower surface of the recording head 19, as long as it can suck ink through the nozzles 21 when making contact with the recording head 19. For example, the cap 24 may suck ink through the nozzles 21 when an upper portion of the cap 24 makes contact with a side of the recording head 19.

In the above embodiments, the fluid injection apparatus may be implemented as a so-called full line type printer where the entire length of the recording head 19 corresponds to the length of the recording paper P in the width direction, in the direction which crosses the direction in which the recording paper P is conveyed.

In the above embodiments, the fluid injection apparatus may be implemented as a so-called off carriage type inkjet printer where ink cartridges 20 are placed in locations other than in the carriage 16. In this case, ink is supplied to the recording head 19 mounted on the carriage 16 from an ink cartridge 20 via a supply tube.

In the above embodiments, the fluid injection apparatus is implemented as an inkjet printer 11. However, the invention is not limited thereto and fluid injection apparatuses for injecting a fluid other than ink (including liquids, fluids where particles of a functional material are dispersed or mixed in a liquid, fluids such as gels, or solids that flows like a fluid and can be ejected) can be implemented.

For example, the fluid injection apparatus may be a fluid injection apparatus for injecting a fluid including dispersed or dissolved electrode material or color material (pixel material), which is used for the manufacture of liquid crystal displays, EL (electroluminescence) displays and surface light emitting displays; a liquid injection apparatus for injecting living organic materials used for the manufacture of biochips; or a liquid injection apparatus for injecting a sample liquid used as a high precision pipette, for example.

Furthermore, the liquid injection apparatus may be a liquid injection apparatus for pinpoint injection of a lubricant in a high precision machine such as a watch or a camera; a liquid injection apparatus for injecting a transparent resin liquid, such as an ultraviolet ray curing resin, onto a substrate in order to form microscopic hemispherical lenses (optical lenses) used for optical communication elements and the like; a liquid injection apparatus for injecting an etchant, such as acid or alkaline, in order to etch a substrate; a fluid injection apparatus for injecting a fluid such as a gel (e.g., physical gel); or a powder injection apparatus for injecting a solid, for example a powder (granules) such as toner (e.g., a toner injection apparatus in a toner jet recording apparatus).

As used herein, “fluid” is a concept that does not include fluids made up of a gas only. Fluid includes, for example, liquids (including inorganic solvents, organic solvents, solutions, liquid resins, liquid metals (melted metal) and the like), fluids, granules and powders.

The present examples and embodiments are to be considered as illustrative and not restrictive and the invention is not to be limited to the details given herein, but may be modified within the scope and equivalence of the appended claims.

What is claimed is:

1. A fluid injection apparatus, comprising:
a fluid injection head having a nozzle forming surface, a nozzle for injecting a fluid onto a target being provided on the nozzle forming surface;
a capping member which makes contact with the fluid injection head in a state where the fluid can be sucked from the nozzle and includes a cap portion which is formed to receive the fluid;
a tank for collecting and holding the fluid discharged from the fluid injection head via the capping member;
a fluid flow path for connecting the cap portion to the tank;
a drive motor which is rotatable in both forward and reverse directions;
a suction pump for sucking the fluid through the inside of the cap portion and the fluid flow path and feeding the fluid toward the tank when the drive motor rotates in the forward direction in the state where the fluid injection head and the capping member make contact with each other; and
a shift preventing apparatus for preventing a positive pressure within the suction pump from shifting into the cap portion by the rotation of the drive motor in the reverse direction when the rotation of said drive motor is switched from the forward direction to the reverse direction.

2. The fluid injection apparatus according to claim 1, wherein the capping member includes a plurality of the cap portions and the fluid flow path includes a plurality of fluid flow paths each of which corresponds to the corresponding one of the cap portions, wherein the fluid injection apparatus further comprises a switching valve apparatus for opening or closing valve bodies each of which is disposed between the cap portion and the suction pump so as to selectively switch each of the fluid flow paths between a connected state and a disconnected state, and wherein, when the operation of the suction pump is stopped when the drive motor rotates in the forward direction, the shift preventing apparatus carries out a closing operation on the valve bodies the switching valve apparatus is driven, and after that, drives the suction pump when the drive motor rotates in the reverse direction.

3. The fluid injection apparatus according to claim 2, wherein the drive motor is a first drive motor and the switching valve apparatus is driven when a second drive motor different from the first drive motor rotates.

4. The fluid injection apparatus according to claim 2, further comprising a transmission switching apparatus for switching the transmission paths in order to selectively transmit the rotation of the drive motor to the suction pump or the switching valve apparatus, wherein the switching valve apparatus is driven when the rotation of the drive motor is transmitted.

5. The fluid injection apparatus according to claim 4, wherein the drive motor is a first drive source and the transmission switching apparatus is driven when power is transmitted from a second drive source different from the first drive source.

6. The fluid injection apparatus according to claim 1, wherein the shift preventing apparatus includes a one-way valve which allows the fluid to move from the cap portion to the suction pump through the fluid flow path while restricting the fluid flow from the suction pump to the cap portion through the fluid flow path.

7. The fluid injection apparatus according to claim 6, wherein the capping member includes a plurality of the cap portions and the fluid flow path includes a plurality of fluid flow paths each of which corresponds to corresponding one of the cap portions, wherein the fluid injection apparatus further comprises a switching valve apparatus for opening or closing valve bodies, each of which is disposed between the cap portions and the suction pump so as to selectively switch each of the fluid flow paths between a connected state and a disconnected state, and wherein the one-way valve is placed between the valve bodies and the suction pump in the fluid flow paths.

8. The fluid injection apparatus according to claim 1, wherein the fluid flow path is formed of a flexible tube connected to inside the cap portion on the first side and connected to inside the tank on the second side and the suction pump includes a pressing member which applies a pressing force to a portion of the flexible tube when the drive motor rotates in the forward direction and reduces the pressing force when the drive motor rotates in the reverse direction.

9. A fluid injection apparatus, comprising:
a fluid injection head having a nozzle forming surface, a nozzle for injecting a fluid onto a target being provided on the nozzle forming surface;
a capping member which makes contact with the fluid injection head in a state where the fluid can be sucked from the nozzle and includes a plurality of cap portions which are formed to receive the fluid;
a tank for collecting and holding the fluid discharged through the fluid injection head via the capping member;
a plurality of fluid flow paths for connecting the cap portions to the tank, each of the fluid flow paths corresponding to one of the cap portions;
a drive motor which is rotatable in at least the forward direction;
a suction pump for sucking the fluid through the inside of the cap portions and the fluid flow paths and feeding the fluid towards the tank when the drive motor is rotated in the forward direction in a state where the fluid injection head and the capping member make contact with each other; and
a switching valve apparatus for opening or closing valve bodies, each of which is disposed between the cap portion and the suction pump so as to selectively switch each of the fluid flow paths between a connected state and a disconnected state,
wherein the switching valve apparatus is driven to close the valve bodies when operation of the suction pump is stopped.

10. The fluid injection apparatus according to claim 9, wherein the drive motor is a motor which is rotatable in both forward and reverse directions, and the fluid injection apparatus further comprises:
a first one-way clutch mechanism for transmitting only the rotation of the drive motor in the forward direction to the suction pump; and
a second one-way clutch mechanism for transmitting only the rotation of the drive motor in the reverse direction to the switching valve apparatus.

11. The fluid injection apparatus according to claim 1, wherein
the capping member has a plurality of cap portions which are the same as the cap portion, and the fluid flow path has a plurality of fluid flow paths which individually correspond to each of the cap portions,
the fluid injection apparatus further comprises a switching valve apparatus for opening or closing valve bodies, each of which intervenes between the cap portions and the suction pump, and thus, for selectively switching each of the fluid flow paths between the connected state and the disconnected state, and
the shift preventing apparatus drives the suction pump when the drive motor rotates in the reverse direction, and after that, drives the switching valve apparatus when the suction pump is stopped being driven when the drive motor rotates in the forward direction in a state where some of the valve bodies are closed.

12. The fluid injection apparatus according to claim 1, wherein the capping member includes a plurality of the cap portions, and the fluid flow path includes a plurality of fluid flow paths each of which corresponds to the corresponding one of the cap portions, wherein the fluid injection apparatus further comprises a switching valve apparatus for opening or closing valve bodies, each of which is disposed between the cap portion and the suction pump so as to selectively switch each of the fluid flow paths between a connected state and a disconnected state, and wherein the shift preventing apparatus includes a delaying apparatus for delaying the transmission of the rotation of the drive motor in the reverse direction to the switching valve apparatus when the rotation of the drive motor is switched from the forward direction to the reverse direction.

13. A liquid injection apparatus, comprising:
a liquid injection head having a nozzle forming surface, a number of nozzles for injecting a liquid onto a target being provided on the nozzle forming surface;
a capping member which makes contact with the liquid injection head in a state where the liquid can be sucked from the nozzles and includes a plurality of cap portions which are formed to receive the liquid;
a tank for collecting and holding the liquid discharged from the liquid injection head via the capping member;
a plurality of liquid flow paths for connecting the cap portions to the tank, each of the fluid flow paths corresponding to one of the cap portions;
a drive motor which is rotatable in both forward and reverse directions;
a suction pump for sucking the liquid through the inside of the cap portions and the fluid flow paths and feeding the fluid toward the tank when the drive motor rotates in the forward direction in a state where the liquid injection head and the capping member make contact each other;
a switching valve apparatus for selectively switching the liquid flow paths between a connected state and a disconnected state by selectively opening and closing valve bodies each of which is disposed between the cap portion and the suction pump when the drive motor rotates in the reverse direction; and
a delaying apparatus for delaying the transmission of the rotation of the drive motor in the reverse direction to the switching valve apparatus when the rotation of the drive motor is switched from the forward direction to the reverse direction.

14. The liquid injection apparatus according to claim 13, wherein the liquid flow paths are formed of flexible tubes connected to inside the cap portions on the first side and connected to inside the tank on the second side and the suction pump includes a pressing member which applies a pressing force to a portion of the flexible tubes when the drive motor rotates in the forward direction and reduces the pressing force when the drive motor rotates in the reverse direction, wherein the delay apparatus transmits the rotation of the drive motor in the reverse direction to the switching valve apparatus after the pressing force is lowered when the rotation of the drive motor is switched from the forward direction to the reverse direction.

15. The liquid injection apparatus according to claim 14, wherein the delay apparatus transmits the rotation of the drive motor in the reverse direction to the switching valve apparatus after application of the pressing force is eliminated when the rotation of the drive motor is switched from the forward direction to the reverse direction.

16. The liquid injection apparatus according to claim 15, wherein the delay apparatus includes a one-way clutch mechanism for transmitting the rotation of the drive motor to the switching valve apparatus only when the drive motor rotates in the reverse direction.

17. The liquid injection apparatus according to claim 16, wherein the one-way clutch mechanism comprises:
a first rotational member which rotates in accordance with the rotation of the drive motor in both forward and reverse directions and includes an internal cog type gear portion;
an external cog type pinion which engages with the internal cog type gear portion of the first rotational member and is rotatable around the axis line of the first rotational member; and
a second rotational member which is rotatable around the axis line and has a contact portion with which the pinion makes contact when rotating as the drive motor rotates, wherein the second rotational member rotates in a predetermined direction around the axis line when the contact portion is engaged with the pinion when the pinion rotates in the first direction around the axis line as the drive motor rotates in the reverse direction, and the switching valve apparatus is driven to open or close each of the valve bodies when the second rotational member rotates in the predetermined direction.

18. The liquid injection apparatus according to claim 17, wherein the pinion rotates in a second direction around the axis line when the drive motor rotates in the forward direction, wherein the contact portion of the second rotational member becomes disengaged from the pinion which rotates in the second direction around the axis line when the drive motor rotates in the forward direction and becomes engaged with the pinion which rotates in the first direction around the axis line when the rotation of the drive motor is switched from the forward direction to the reverse direction, wherein the second rotational member rotates in the predetermined direction when the rotating movement of the pinion is transmitted when the contact portion is engaged with the pinion.
